(19) United States
(12) Patent Application Publication
(10) Pub. No.: US 2020/0240306 A1
(43) Pub. Date: Jul. 30, 2020

(54) METHOD FOR THE AFTERTREATMENT OF EXHAUST GASES IN A HYBRID MACHINE

(71) Applicant: Robert Bosch GmbH, Stuttgart (DE)

(72) Inventor: Christoph Osemann, Karlsruhe (DE)

(21) Appl. No.: 16/776,500

(22) Filed: Jan. 29, 2020

(30) Foreign Application Priority Data
Jan. 30, 2019 (DE) 10 2019 201 157.8

(51) Int. Cl. F01N 3/20; B60K 6/22; B60W 20/00

(52) U.S. Cl. CPC F01N 3/2013; B60Y 2200/92; B60W 20/00; B60K 6/22

(57) ABSTRACT

A method for exhaust gas aftertreatment in a hybrid machine comprising at least one electric motor (2) and one internal combustion engine (3) is disclosed, wherein the method comprises operating the hybrid machine in a first operating mode in which only the electric motor (2) is switched on and an internal combustion engine (3) is switched off; determining whether heating of an exhaust gas aftertreatment system (20) of the hybrid machine is required; and, if heating is required, at least temporarily activating the internal combustion engine (3) for the purpose of heating the exhaust gas aftertreatment system (20).

### BACKGROUND OF THE INVENTION

The present invention relates to a method for the aftertreatment of exhaust gases in a hybrid machine and also to a computer unit and to a computer program for carrying out said method.

Hybrid machines, such as hybrid vehicles for example, called “hybrids” for short in the text which follows, are by definition equipped with an internal combustion engine and an electric drive.f

The electric motor is generally used first in the switch-on process of the vehicle or of the machine. The internal combustion engine is then, at least partially, activated or operated instead of the electric drive during further operation for the purpose of increasing the total power, for the purpose of reducing the power consumption and/or for the purpose of increasing the range and period of operation.

As in conventional machines, the internal combustion engine used generates combustion gases corresponding to the power called up by the internal combustion engine. However, unlike conventional driving, the internal combustion engine of the hybrid does not necessarily start when a machine is stationary, but rather is often only started during driving operation. In general, the following also holds true: the more power is called up, the higher the emissions of the engine.

In this case, emissions during driving operation in practice (RDE, real driving emissions) are often substantially higher than the emissions which are ascertained in a laboratory during statutory test cycles. Said emissions are also regulated for hybrids by prescribed RDE values, as prespecified in EU Commission Regulation 2017/1154 of 7 Jun. 2017. The objective is, in principle, to achieve comparable emission values in hybrids as in conventional drives and at least to comply with the limit values for said emission values.

In order to comply with said limits for the emission values, exhaust gas aftertreatment is necessary, as in the conventional case. However, the exhaust gas aftertreatment system requires a certain operating temperature in order to ensure the necessary conversion of the harmful gases for the purpose of complying with regulated emissions, and operates in an optimal manner only in a specific temperature range. Therefore, it is advantageous when the exhaust gas aftertreatment system is rapidly heated and also does not fall below its minimum operating temperature during operation.

Exhaust gas aftertreatment systems are conventionally heated up by the exhaust gas stream; however, the pollutant stream which is insufficiently treated until the operating temperature of the exhaust gas aftertreatment system is reached may be considerably and impermissibly high. This is a problem particularly in the case of hybrids where a high power is often called up spontaneously and irregularly by the internal combustion engine, while in other phases only the electric drive is connected. Therefore, when the internal combustion engine is briefly activated during driving operation on account of required power, the exhaust gas aftertreatment system which is not yet (or no longer) sufficiently heated at this time cannot sufficiently convert the harmful gases. This situation therefore requires greater expenditure for exhaust gas aftertreatment than in vehicles and machines with a conventional drive.

### SUMMARY OF THE INVENTION

The invention proposes a method for exhaust gas aftertreatment in a hybrid machine, in particular a hybrid vehicle, and also a computer unit and a computer program for carrying out said method having the features of the independent patent claims. Advantageous refinements are the subject matter of the dependent claims and also of the following description.

The invention is based on the measure of checking, in a hybrid machine comprising an electric motor and an internal combustion engine, whether heating of the exhaust gas aftertreatment system is required in order to reduce emission values—which also include carbon dioxide—and accordingly to at least temporarily activate the internal combustion engine for heating purposes in electric mode too. Targeted activation of the internal combustion engine can therefore prepare the exhaust gas aftertreatment system for higher motor powers which are required at a later time.

In one embodiment, determining whether heating of an exhaust gas aftertreatment system is required can be performed on the basis of evaluation of measurement data, wherein the measurement data has been obtained, at least in part, during previous operation of the hybrid machine and measurement data comprises, for example, the temperature of the exhaust gas aftertreatment system, power data of the electric motor and/or of the internal combustion engine or values relating to the composition of an exhaust gas stream.

Determining whether heating of the exhaust gas aftertreatment system is required could also include a prediction of future measurement data which is expected in a specific time period, wherein the prediction is calculated on the basis of stored measurement data which could have originated, for example, from previous operation or from collected vehicle data of other vehicles. As an alternative or in addition, the prediction could be performed on the basis of data which defines the drive power which is expected to be required in a predetermined future time period. Data of this kind can be time of day, date, internal and external temperature and weather data (measurement values of temperature, atmospheric humidity, light intensity, precipitation, a rolling resistance and slip of the wheels of the motor vehicle), optical traffic sign identification, state of charge of the energy stores (“rechargeable batteries”) and forecasts (for example local weather forecasts). Data of this kind could also be, for example, navigation data on the basis of which route profiles, speed limits, positive gradients, turnings and/or stop points can be identified. Data of this kind can also be based on actual traffic situations, for example by means of the measurement of a distance radar, and the expected traffic situation on the route ahead, the traffic density on said route, average speed (for example congestion forecast), and calculated therefrom. Vehicle settings (in particular so-called “drive modes”, for example autonomous, partially autonomous, assistance system-assisted or purely manual driving, load-optimized, comfort-oriented, time-optimized or dynamic driving) actually selected by the driver and driver profiles (in particular driving-dynamics characteristics such as acceleration, distance, coasting and braking behavior, in particular also when these lead to power being called up, or to electrical energy being recovered) based on historical data, and preferences in respect of temperature control and air conditioning before (for example precooling, or auxiliary heating) and during operation of a vehicle (in particular if these require a high power) are further examples which can be used for predicting future measurement values.

The use of the collected and calculated data is not necessarily restricted to a single machine. One advantage is the direct or indirect communication between two, a few or a relatively large number of machines in a cluster, or in a plurality of clusters which are connected to one another. Connection of the machine to the Internet is advantageous for transmitting, storing and evaluating said data for a subsequent similar, or different, use. According to one embodiment, during evaluation, the measured and/or predicted measurement data is preferably compared with at least one prespecified threshold value, and, in the event of at least one prespecified threshold value being undershot or exceeded (for example temperature of the exhaust gas aftertreatment system is too low), it is determined that heating is required. Therefore, it can be ensured that the exhaust gas aftertreatment system always remains in the region of the minimum or optimum operating temperature, or at least at a defined minimum temperature from which sufficiently rapid reheating is possible.

In a further embodiment, activation of the internal combustion engine can be performed at predetermined times and/or within a predetermined period of time. Said times can be stored and complied with on their own, or combined with further evaluations and predictions. Said predetermined times and/or the predetermined duration of activation can optionally be changed during operation, depending on stored data or recorded measurement data. The change can be performed once or can be stored as a permanent change.

In a further embodiment, electrically heating at least one part of the exhaust gas aftertreatment system can be performed in a prespecified period of time, before the internal combustion engine is activated for the purpose of heating the exhaust gas aftertreatment system. In this way, the times during which the internal combustion engine has to be activated for heating purposes can be kept relatively short, or a low power can be called up by the internal combustion engine during said time.

Implementing a method according to the invention in the form of a computer program or computer program product with program code for carrying out all of the method steps is also advantageous since this results in particularly low costs, in particular if an executing control device is further used for other tasks and is therefore present in any case. Suitable data carriers for providing the computer program are, in particular, magnetic, optical and electrical storage devices, such as hard drives, flash memories, EEPROMs, DVDs etc. for example. It is also possible to download a program via computer networks (Internet, intranet, mobile radio link etc.).

A computer unit according to the invention, for example a control device of a motor vehicle, is designed, in particular in respect of programming, to carry out a method according to the invention.

The invention is schematically illustrated in the drawing on the basis of exemplary embodiments and will be described in more detail below with reference to the drawing.

### BRIEF DESCRIPTION OF THE DRAWINGS

FIG. 1 schematically shows an exhaust gas aftertreatment system according to one embodiment of the invention,

FIG. 2 shows, by way of example, a flowchart of a general method according to embodiments of the invention, and

FIG. 3 shows, by way of example, a flowchart of exemplary method steps according to embodiments of the invention.

### DETAILED DESCRIPTION

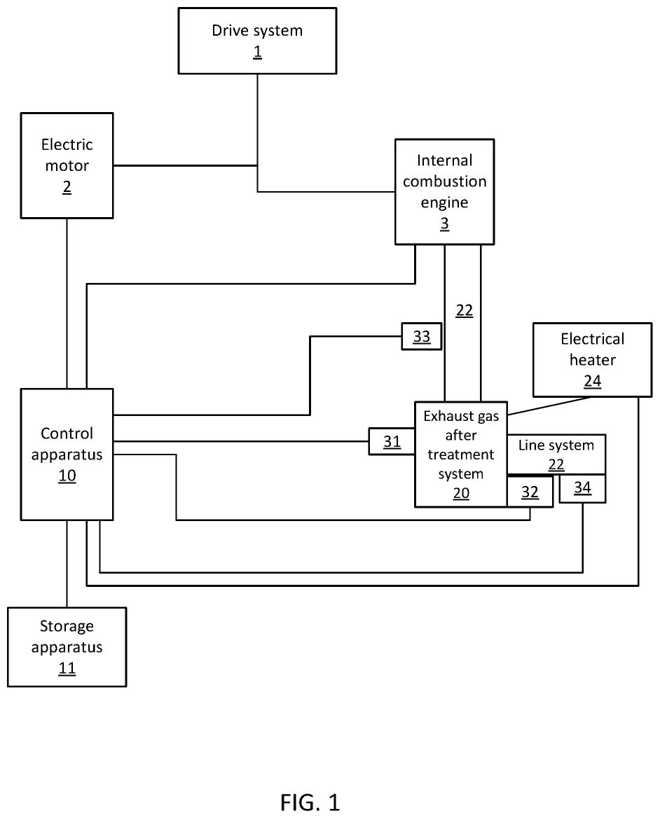

FIG. 1 schematically shows an exemplary system, such as a vehicle for example, in which a method according to the invention can be employed. In this case, a drive system 1 is driven in a combined manner by an electric motor 2 and an internal combustion engine 3 as a hybrid. The exhaust gases of the internal combustion engine are conducted to an exhaust gas aftertreatment system 20 via a line system 22. An electrical heater 24 can optionally be present in order to heat parts of the exhaust gas aftertreatment system.

A control apparatus 10 can be used for controlling the motor 2 and engine 3 and likewise for regulating and monitoring the operating temperature of an exhaust gas aftertreatment system 20 for the purposes of the invention. Even though the control apparatus is illustrated as a single module here, it may comprise a plurality of separate or connected modules with different tasks. A suitable storage apparatus 11 can be connected to the control apparatus.

By way of example, various sensors 31, 32, 33, 34 can be fitted to the exhaust gas aftertreatment system 20, to the motor 2 or engine 3, in the exhaust gas lines 22 or in other suitable locations, it being possible for the control apparatus to read out the data of said sensors or which data is passed on to the control apparatus from another point.

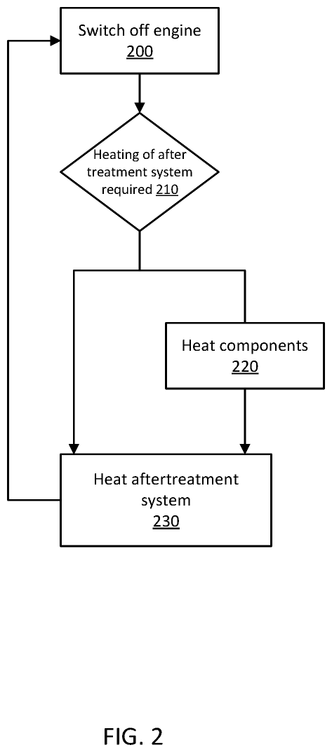

The basic sequence of a method according to the invention is shown by way of example in FIG. 2.

According to a first embodiment, in a hybrid machine, the hybrid is initially operated in an electric drive mode, that is to say only using the electric motor 2 while the internal combustion engine 3 is switched off, in step 200. The control apparatus 10 or another control device of the hybrid usually controls when and for how long the internal combustion engine is activated, for example for the purpose of increasing the drive power or for the purpose of saving electrical energy.

According to one embodiment, it is now additionally determined in step 210 whether heating of the exhaust gas aftertreatment system 10 is required. If this is the case, activation of the internal combustion engine for the purpose of heating of the exhaust gas aftertreatment system can be initiated in step 230. Optionally, heating 220 of components by means of, for example, an electrical heater can have already taken place beforehand, as will be described in greater detail below.

For example, in a simple embodiment, it can be defined that the internal combustion engine is activated for heating purposes in an electric drive mode at defined time intervals. The duration of activation and also the operating state, selected for this purpose, of the internal combustion engine can likewise be defined in advance, so that irregular or regular periodic activation results. As an alternative, an internal combustion engine can also be operated over a relatively long time period, optionally with situationally modulated power call up and correspondingly variable operating states, up until continuous activation (for example at predetermined powers in selected operating states), in particular if a required operating temperature of the exhaust gas aftertreatment system cannot be reached in another way. Time-related rules in accordance with which activation of the internal combustion engine should be performed can be defined and stored in this way. The control apparatus can once again call up said rules and initiate activation of the internal combustion engine in a corresponding manner.

For example, in one embodiment, it can be defined that the internal combustion engine is activated for heating purposes in an electric drive mode and the power generated in the process serves, depending on the situational conditions, for propelling the vehicle (or accordingly for mechanical work, for example in the case of an agricultural or construction machine), or for charging electrical energy stores (“rechargeable batteries”). In this case, the internal combustion engine can be operated in a particularly expedient manner in respect of heat output to the exhaust gas aftertreatment system, emissions and fuel consumption. This is also achieved, in particular, in situations in which the power of the internal combustion engine is not or not substantially intended to serve to perform mechanical work (for example propulsion). The duration of activation and also the operating state, selected for this purpose, of the internal combustion engine can likewise be defined in advance, so that irregular or regular periodic activation results.

A control apparatus can likewise determine whether heating is required and regulate activation of the internal combustion engine on the basis of measured or stored data, or else modify the predetermined conditions for activation of the internal combustion engine on the basis of data of this kind during operation.

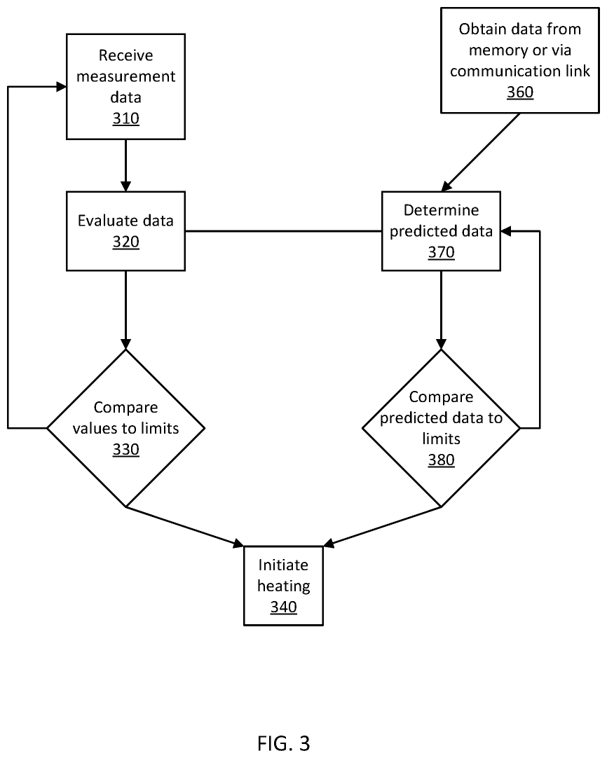

Various options are available for evaluating data and regulating activation. FIG. 3 shows an exemplary detailed sequence of a determining step 210 from FIG. 2 in the form of a further process flowchart, wherein the steps do not all necessarily have to be executed and do not necessarily have to be executed in the order shown. In addition, further method steps which are not shown in the figure can take place. The described sequence mentions only one possible embodiment.

In step 310, the control apparatus receives measurement data from sensors. As an alternative, said data can be read out from another apparatus and passed on.

In step 320, said data is now evaluated and processed, for example averaged over a specific time period or converted into a prespecified form, or converted into the appropriate value by predetermined calculation methods.

Then, in step 330, said obtained values are compared with one or more limit values. If the values lie within the predetermined range, the control apparatus continues to continuously check the measurement values and evaluates the next row of measured data, back to step 310 (or alternatively 320). However, if a predetermined limit value or threshold value which indicates the need to heat the exhaust gas aftertreatment system is exceeded, said heating is initiated in step 340. This may involve immediate activation of the internal combustion engine or previous electric heating of the exhaust gas aftertreatment system, or else defining a specific time at which the heating is started. Said following steps then once again correspond to steps 220 or 230 in FIG. 2.

It is likewise possible to not or not only directly compare the evaluated actual measurement data with threshold values in step 330, but rather to make a prediction about future values using various calculation methods on the basis of the existing values instead, step 370.

If a suitable prediction has been made, the values obtained in this way for a specific future time or time period can be compared with threshold values in step 380 once again. If the calculated future values lie within the prespecified limits, no heating is planned for and further values are evaluated or predicted, back to step 370. However, if at least one of the predicted values which is relevant for the determination lies outside (above and/or below, depending on the value) the prespecified limits, heating of the exhaust gas aftertreatment system is initiated in step 340. Once again, this may involve immediate heating by determining a time at which heating should start or the internal combustion engine should be activated, or by modifying rules which define activation and heating. It goes without saying that actual measurement data from step 310 or 320 can also be included in the prediction in step 370.

Instead of or in addition to evaluation or prediction on the basis of actual measurement data in steps 320 and 370, the control apparatus can also use further data, which is obtained from a different source or has been stored in the control apparatus or with connection thereto, in the determination. The control apparatus obtains this data in step 360 by calling it up from a memory apparatus or via a communications link. Said data can then be included, on its own or together with actual data, in the comparison of the threshold values, either directly or with prior further processing.

For example, measurement values from sensors 31, 32, 33, 34 and other elements which had been obtained during previous operation of the hybrid can be obtained (310) and evaluated (320). To this end, for example, actually and continuously measured values can be used and/or data which was measured and stored over a relatively long time or data which is available via a communications link can be assessed. Measurement values of this kind can comprise, for example, the temperature at one or more points in the exhaust gas system, in particular the temperature of the exhaust gas aftertreatment system, which temperature is measured at a suitable point by a sensor 31, but also, as an alternative or in addition, temperatures of the exhaust gas stream upstream, 33, or downstream, 34, of the exhaust gas aftertreatment system. Furthermore, the measurement values can comprise exhaust gas characteristic values, which relate to the constituent parts and/or concentrations and/or volumes and/or composition of the exhaust gas stream and, in particular, the contained harmful substances, or data which allows inferences to be made about said exhaust gas characteristic values. Said measurement values can likewise be measured by sensors 32 upstream and/or downstream of the exhaust gas aftertreatment system, or can be calculated from data. Power data of the motor and engine, such as the average power over a prespecified time period or the called up maximum power, can also be evaluated like the energy and fuel consumption. All of this and further data can be evaluated individually or in combination in order to control heating of the exhaust gas aftertreatment system. Data can also be present in stored form or called up in a suitable manner (360) in order to supplement the actual measurement data. It goes without saying that the evaluation of the measurement values can be employed in combination with the defined time intervals, as described above.

In this case, one or more threshold values can be employed in step 330 in order to determine whether heating is required and which measures for heating purposes are taken. If a threshold value is undershot (for example that of the required or optimum operating temperature) and/or exceeded (for example that of harmful substances in the exhaust gas stream), a decision can then be made in step 340 as to when and whether the internal combustion engine is activated. The system could optionally identify which threshold values are applicable at the actual and at the prespecified or actually predicted route ahead when a vehicle is located, for example, in a specific region with specific regulations (for example legislation) and this is known by means of a positioning system of the vehicle, the actually used threshold values can be accordingly adapted, for example to localizable limits of specific regional zones, for example urban residential areas such as inner cities, villages and agricultural holdings (in which, for example, a combine harvester is operated in a different mode to that on the road outside the village on its way to the field), coastal regions, harbors (in contrast to open water areas and deep sea regions). In this way, a time-limited, or local, for example inner-city, operating restriction of the internal combustion engine can be taken into account for example.

The measurement data and/or the predicted data can also be used in step 340 in order to modify rules for the purpose of activating the internal combustion engine which have already been defined. If, for example, evaluation of the measurement data shows that specific limit values or threshold values are regularly reached in specific situations, the predefined time period until the next activation for heating purposes can then accordingly be adjusted in respect of its power call up, or shortened in respect of time. This adjustment can also be permanently defined. In this way, rules for activation purposes can be adjusted in a variable manner during operation of the hybrid, in particular in the manner of a feedback controller in which checks are continuously made as to whether the actually applied regulations correspond to optimum operation of all of the components and otherwise the rules can be adjusted. Different rules can also be defined for different operating modes, that is to say for purely electric operation, for pure internal combustion engine operation and for combined operation by electric motor and internal combustion engine.

In addition to the direct evaluation of measurement data and the decision on this basis, according to one possible embodiment of the invention, a prediction can also be determined in step 370. A prediction of this kind can comprise a numerical extrapolation of a defined future time period on the basis of the measurement data or more complicated methods for prediction and feedback, such as fuzzy logic methods and neural networks for example. If, for example, it is known from previous operation or from stored data (360) how the emission values in the exhaust gas rise or fall depending on the activation of the internal combustion engine, this data can be used in order to estimate, by means of suitable calculations, temperature and emission value behavior expected in the future and to determine regulation for the activation of the internal combustion engine on this basis (370). To this end, the predicted data is then once again compared with limit values in step 380, in a comparable manner to step 330 for the actual measurement values.

Determining whether heating will be required, and the corresponding prediction for a prespecified time period, can also be determined on the basis of navigation data, traffic, weather and similar forecasts. If, for example, it is possible to determine by means of a navigation system of the vehicle the route on which the vehicle is located, data about the expected routes ahead can be derived at least for a limited time period, for example until the next turning. Data of this kind could contain information relating to speed profiles of vehicles located there, delays such as congestion, traffic lights, field and sea markers and/or route profiles such as positive gradients, negative gradients, speed limits and additional information from communications links, for example local weather conditions from the Internet. Vehicle settings selected by the driver (for example autonomous and consumption-optimized driving) and typical driver profiles and user-related preferences, for example the air conditioning of the vehicle interior, acceleration and braking behavior, can also be used for predictions of this kind. On this basis, the system can then estimate the power values called up in the next time and, in accordance with defined rules, determine whether and when the operating temperature of the exhaust gas aftertreatment system is likely to fall below a threshold value and heating will be required. Once again, this data can also be combined with actual or older measurement values as described above from the operation of the hybrid in order to be able to predict the values as exactly as possible. Certain characteristic data can also be prestored in the system, or can be called up via a communications link, for example by the manufacturer, which characteristic data describes relationships between temperature, power and emission values taking into account the abovementioned additional information and can be used for calculation and prediction purposes.

As an alternative or in addition to local regulation, measurement data could also be transmitted to a different location via a communications link, for example to a central processing point where said measurement data is evaluated and/or corresponding prediction data is calculated and only the resulting rules for activating the engine are transmitted back to the local control apparatus again.

A further option in order to achieve the required operating temperatures is that of directly heating parts of the exhaust gas aftertreatment system (or the entire system), preferably by electric heater 24. Therefore, for example, sensors, gas mixing elements, catalysts, pipelines and other components could be electrically heated in specific regions, or completely. This is already achieved with a low-voltage hybrid, but higher voltages are advantageous.

In particular, electrical heating of parts of the exhaust gas aftertreatment system can already be performed, see step 220 in FIG. 2, when the internal combustion engine is not or not yet activated. Electrical heating can then be performed continuously, at defined intervals or respectively in a defined time period in an unchanged manner with modulated power before starting the machine or before activating the internal combustion engine. In this case, electrical heating can also take place independently of whether activation of the internal combustion engine is performed for increasing the drive power or, according to the invention, for increasing the temperature of the exhaust gas aftertreatment system. For example, the abovementioned prediction models can be used in order to already preheat the system using the electrical heater beforehand in the case of an expected high drive power and as a result expected activation of the internal combustion engine for drive purposes.

As soon as the control apparatus defines that activation of the internal combustion engine should be performed soon, it can send a signal for electrical heating to corresponding elements. As an alternative, it could be defined, for example, that electrical heating is performed at specific time intervals when the internal combustion engine is switched off, even if the internal combustion engine will not be or will not certainly be activated in the foreseeable future. Similarly, an optional temperature measurement can again be included in the decision regarding electrical heating, so that, in the event of a threshold temperature being undershot, electrical heating of the exhaust gas aftertreatment system is performed until a desired minimum temperature is reached. When said minimum temperature is reached, the internal combustion engine can then be switched on in addition or as an alternative. In one possible embodiment of the invention, the signal for activating the internal combustion engine is produced only when a predetermined temperature of the exhaust gas aftertreatment system is reached.

It is also possible, in the case of motor control device-defined or expected activation of the internal combustion engine at a high power, for a preliminary first stage of activation for heating purposes to always be performed first, the internal combustion engine being operated at a low power and the remaining drive power continuing to be provided by the electric motor in said first stage. The power of the internal combustion engine can then be increased after a defined time or after a desired operating temperature of the exhaust gas aftertreatment system is reached. The power of the internal combustion engine could likewise be increased in stages or continuously starting from the heating phase.

The control apparatus, which performs activation of the internal combustion engine for heating purposes, determining of regulation data, prediction of data and, for example, monitoring of the temperature values, can be the control device of the engine. However, it may likewise be a separate control device or another controller which performs other tasks or is designed only for this regulation.

When the internal combustion engine is intended to be activated in order to heat the exhaust gas aftertreatment system, the control apparatus will ideally permit only so much power that the emissions always remain below the defined limit value in the process. The emissions generated by activation of the internal combustion engine should therefore continuously be included in control of the heating in order to not exceed the limit values. The internal combustion engine runs, for heating purposes, at a comparatively low power; the rest of the power which is called up by the vehicle is preferably still provided by the electric motor.

To this end, according to one possible embodiment, the volume and/or the composition of the exhaust gas stream is at least temporarily and partially measured by one or more sensors, or calculated from stored data or data which is called up via a communications link after activation of the internal combustion engine. This ascertaining process can take place continuously or at defined intervals. A control apparatus, such as the motor control device, processes the sensor signals and monitors compliance with threshold values. The threshold values used can be the regionally prescribed, that is to say for example the statutory, limit values as well as other or additional threshold values which differ therefrom (for example defined by the manufacturer). It would be conceivable, for example, to use different stepped threshold values below the statutory limit value in order to define the initiation of different measures for improving the emission values.

The threshold values are preferably stored in a storage unit of the processing control apparatus.

If the sensor signals which are measured and received at the control apparatus indicate a threshold value being exceeded in the exhaust gas stream, the control apparatus can now initiate additional measures which can lead to the minimum operating temperature or a specific desired operating temperature of the exhaust gas aftertreatment system being reached.

In this case, various methods are possible in order to continue to heat the exhaust gas aftertreatment system. For example, a limited exhaust gas stream, which is particularly suitable for heating, can be passed to the exhaust gas aftertreatment system, said exhaust gas stream heating said exhaust gas aftertreatment system for a subsequent higher exhaust gas stream, permanently or for a limited time, for example for less than 600 seconds, advantageously for less than 60 seconds and particularly advantageously only for a few seconds.

To this end, for example, different substances which are suitable for increasing the temperatures of the exhaust gas aftertreatment system can be added to the exhaust gas stream. One option involves supplying combustible substances to the exhaust gas stream within the engine or directly to the exhaust gas aftertreatment system, so that said combustible substances can be at least partially converted into heat by combustion processes. Substances of this kind are, for example, fuels, nitrogen oxide (NO), methanol and other additives known in the art which can be injected at a suitable point. As an alternative or in addition, the combustion gas can be enriched with adsorbable/absorbable substances and/or adsorbable/absorbable substances can be added to the exhaust gas stream, said adsorbable/absorbable substances then at least partially leading to heating of the exhaust gas aftertreatment system. Substances which are suitable for this purpose are likewise known, such as water, urea solution, ammonia (NH₃), nitrogen oxides (NO, NO₂). The adsorption/absorption sites of the exhaust gas aftertreatment system should be regenerated at a later time.

Methods in which various measures for heating the exhaust gas aftertreatment system are combined with one another are also advantageous, for example—not necessarily completely and not necessarily in this chronological order—by electronically heating at least one preferably functional unit (for example mixer pipe, gas mixer, catalyst etc.) through which gas flows (possibly only later) in order to bring said functional unit to its minimum operating temperature; generating heat of absorption in the exhaust gas aftertreatment system by absorption of molecules, for example as a result of metered addition of a reducing agent (for example NH₃, urea solution, propene etc.), and/or as a result of the supply and adsorption of incompletely combusted fuel; measures within the engine for increasing the exhaust gas temperature including high-pressure EGR (exhaust gas recirculation) and/or low-pressure EGR; supply of oxidizable molecules (hydrocarbons, incompletely combusted fuel, NH₃ etc.) to oxidizing catalyst components for generating heat of combustion in the exhaust gas aftertreatment system.

The method according to the invention relates to any type of hybrid machine, such as, for example, low-voltage hybrids, high-voltage hybrids, plug-in hybrids, range extender hybrids, in particular hybrid vehicles. The described method is likewise independent of the type of hybrid machine, examples of which may be: low-duty (LD), medium-duty (MD) and high-duty (HD) hybrids, including buses; off-highway machines, including motor boats, aircraft, for example small aircraft, locomotives, or large motors, for example for ships. The method can be employed with any form of internal combustion engine in hybrids, amongst others hybrids with diesel engines, petrol engines, and with gas- or methanol-operated motors.

Since all exhaust gas aftertreatment systems require a minimum temperature for converting the harmful gases, which minimum temperature lies above the ambient temperature, the described method can be applied to any method of the exhaust gas aftertreatment of hybrids and all combinations thereof, amongst others to NOₓ storage catalysts such as an NSC (NOₓ storage converter) and three-way catalysts (TWC); to NH₃ reservoirs, such as SCR (selective catalytic reduction) catalysts for example; to oxidizing catalysts, such as DOC (diesel oxidation catalysts), NSC, TWC, AMOX (NH₃ oxidation catalysts) for example, and reducing catalysts such as, for example, SCR, NSC, TWC; to particulate filters with and without oxidizing or reducing coating. The limit temperatures can be adjusted in accordance with the required and optimum operating temperatures.

In this case, the method, in particular when recording measurement data, heating elements and also regulating additives and operating conditions, can include any components of exhaust gas aftertreatment, for example gas mixers and two-substance mixers; liquid atomizers and evaporators (hydraulically, mechanically and electrically operated), including the connection points thereof, cables and software; catalyst housings (canning), filters, cyclones, gas scrubbers, pipelines, decoupling elements, mixing chambers and other components manufactured from metal which, under certain circumstances, can be detached from one another; sensors (volumetric flow, temperature, NOx, particulate, lambda, NH₃, O₂, NO, NO₂, N₂O, absolute, differential pressure, oxidation potential, conductivity etc.) including the connection points thereof, cables and software, and any desired combinations thereof.

It is emphasized once again that the stated method steps, such as predefined activation of the internal combustion engine, prediction of power peaks, evaluation of measurement data, prediction of future measurement data, changing of predefined activation rules and so on for example, can also be combined with one another or used in parallel in any desired manner in order to achieve optimum emission behavior together with the desired drive power and consumption optimization in a convenient manner.

1. A method for exhaust gas aftertreatment in a hybrid machine comprising at least one electric motor (2) and one internal combustion engine (3), wherein the method comprises:
operating the hybrid machine in a first operating mode (200) in which only the electric motor (2) is switched on and an internal combustion engine (3) is switched off;
determining (210) whether heating of an exhaust gas aftertreatment system (20) of the hybrid machine is required; and,
if heating is required, at least temporarily activating (230) the internal combustion engine (3) for the purpose of heating the exhaust gas aftertreatment system (20).

2. The method for exhaust gas aftertreatment according to claim 1, wherein determining (210) whether heating of an exhaust gas aftertreatment system is required is performed on the basis of evaluation of measurement data (320), wherein the measurement data has been obtained, at least in part, during previous operation of the hybrid machine, wherein the measurement data is at least one of selected from the group consisting of temperature of the exhaust gas aftertreatment system, power data of the electric motor, and power data of the internal combustion engine, and values relating to the composition of an exhaust gas stream.

3. The method for exhaust gas aftertreatment according to claim 1, wherein determining whether heating of the exhaust gas aftertreatment system is required includes a prediction of future measurement data (370) which is expected in a predetermined time period, wherein the prediction is calculated on the basis of stored data, data which is accessible via a communications link, actual measurement data, or a combination of the same.

4. The method for exhaust gas aftertreatment according to claim 3, wherein the prediction is calculated on the basis of data which defines the drive power which is expected to be required in a predetermined future time period.

5. The method for exhaust gas aftertreatment according to claim 2, wherein the measured data, the predicted measurement data, or both are compared with at least one prespecified threshold value (330, 380), and wherein, in the event of at least one prespecified threshold value being undershot or exceeded, it is determined that heating is required (340).

6. The method for exhaust gas aftertreatment according to claim 1, wherein activation of the internal combustion engine (230) is performed at a predetermined power output at predetermined times, within a predetermined duration of activation, or both.

7. The method for exhaust gas aftertreatment according to claim 6, wherein the predetermined times, the predetermined duration of activation, the predetermined power output, or a combination of the same is changed during operation depending on at least one selected from the group consisting of stored data, transmitted data, and recorded measurement data.

8. The method for exhaust gas aftertreatment according to claim 1, further comprising electrically heating (220) at least one part of the exhaust gas aftertreatment system in a prespecified time period.

9. A computer configured to control a hybrid machine comprising at least one electric motor (2) and one internal combustion engine (3), to:
operate in a first operating mode (200) in which only the electric motor (2) is switched on and an internal combustion engine (3) is switched off;
determine (210) whether heating of an exhaust gas aftertreatment system (20) of the hybrid machine is required; and,
if heating is required, at least temporarily activate (230) the internal combustion engine (3) for the purpose of heating the exhaust gas aftertreatment system (20).

10. A non-transitory, computer-readable storage medium containing computer-excutable instructions that when executed by a computer cause the computer to control a hybrid machine comprising at least one electric motor (2) and one internal combustion engine (3), to:
operate in a first operating mode (200) in which only the electric motor (2) is switched on and an internal combustion engine (3) is switched off;
determine (210) whether heating of an exhaust gas aftertreatment system (20) of the hybrid machine is required; and,
if heating is required, at least temporarily activate (230) the internal combustion engine (3) for the purpose of heating the exhaust gas aftertreatment system (20).
